(19) United States
(12) Patent Application Publication
(10) Pub. No.: US 2024/0195245 A1
(43) Pub. Date: Jun. 13, 2024

(54) ROTOR

(71) Applicant: YASA LIMITED, Kidlington Oxfordshire (GB)

(72) Inventors: Simon ODLING, Kidlington Oxford Oxfordshire (GB); Graeme HYSON, Kidlington Oxford Oxfordshire (GB); Jack HODGSON, Kidlington Oxford Oxfordshire (GB); Callum PICKEN, Kidlington Oxford Oxfordshire (GB)

(21) Appl. No.: 18/288,001

(22) PCT Filed: Apr. 22, 2022
(86) PCT No.: PCT/EP2022/060727

§ 371 Date: Oct. 23, 2023

(30) Foreign Application Priority Data
Apr. 23, 2021 (GB) 2105829.2

(51) Int. Cl. H02K 1/2798; H02K 15/12; H02K 21/24

(52) U.S. Cl. CPC H02K 1/2798; H02K 15/12; H02K 21/24

(57) ABSTRACT

A rotor for a rotary electric machine is described, the rotor comprising a support disc having opposing first and second faces, a support member, and a plurality of permanent magnets mounted to and retained by the support member, wherein the support member is secured to the first face of the support disc.

### FIELD OF THE INVENTION

This invention relates to a rotor for a rotary electric machine such as an electrically powered motor or a generator. In particular, it relates to a rotor suitable for use in an axial flux motor, in which stators cooperate with rotors across an air gap, the air gap being in the direction of flux traversal and being predominantly parallel the axis of rotation, but it will be appreciated that the invention is not restricted to such use.

### BACKGROUND OF THE INVENTION

GB 2468018 describes a machine comprising a series of coils wound around pole pieces spaced circumferentially around the stator and spaced axially (ie parallel the rotational axis of the rotor) from the associated rotor. The rotor has two stages comprising discs provided with permanent magnets that face either end of each electromagnetic coil of the stator.

Rotor stages typically comprise a hub region and an annular ring, the annular ring being of soft magnetic material and used to convey magnetic flux between adjacent magnets, the magnets being surface mounted and spaced circumferentially around the rotor stage annular ring and disposed axially, ie parallel the rotation axis of the rotor. High rotational rotor speeds generate high centripetal force on rotor stages particularly on surface mounted magnets and loss of magnet adhesion is a risk for this motor topology. It is possible for the annulus and hub regions to be continuous, made of the same material and is typically a ferromagnetic steel, however ferromagnetic steel is conductive and eddy current losses are generated during use. To reduce eddy currents it is possible for the annular ring to hold a soft magnetic material, the soft magnetic material being soft magnetic powder composite or laminated electrical steel, the soft magnetic material being substantially capable of carrying magnetic flux between adjacent surface mounted magnets, but suppresses current flow in this same plane, it being of high electrical resistance in a plane substantially radial to the motor axis.

Also known are double stator single rotor axial flux motors wherein said single rotor contains magnets disposed circumferentially with pole faces, facing across air gaps to stator electromagnetic coils similarly disposed. Double stator machines preferably have rotors comprising a non-magnetic matrix, the matrix having embedded magnets disposed circumferentially, the magnets having their pole faces aligned predominantly parallel the axis of rotation, the magnetic north and south pole faces facing across air gaps towards the stators.

Double stator, single rotor axial flux machines benefit from substantially equal magnetic forces applied when at rest, and when in use, as the rotor acts cooperatively with both stators and the magnetic field induced axial forces on the rotor are substantially balanced. Double stator, single rotor machines do not need a rotor magnetic yoke to carry permanent magnets, hence saving of yoke weight, and because axial forces are substantially balanced a rotor for such a machine can be of comparatively low stiffness. However these advantages come at the cost of two stators and their back yokes, which when assembled are typically of greater axial length than single stator, double rotor axial flux machines. However to obtain a short axial length, the rotor construction needs to achieve stiffness and integrity at rest and under load.

There is advantage in motors of the present invention in maximising torque generated by antagonistic magnetomotive force between stator and rotor by minimising air gaps between stator and rotor consistent with stiffness of said rotor stages and stack tolerances of pertinent components. With minimised stator to rotor air gap there is potential for significant axial load between the rotor stage and motor stator at rest and during operation and it is preferable for the rotor to be stiff so as to resist bending which might otherwise interfere with the stator.

A problem to be solved by the present invention is to achieve sufficient stiffness of the rotor stage so as to minimise movement towards said stator, whilst minimising the rotor stage mass, minimising eddy currents and maximising magnetic flux carrying capacity. Another problem for motors of the present invention is to maintain integrity of rotor stages that in the course of normal operation are caused to rotate at high rotational speed, which speed induces large centripetal forces on magnets and so stresses attachment between surface mounted magnets and said annular ring to which they are fixed.

Another problem to be solved for motors of the present invention is thermal expansion mismatch between magnet materials of rare-earth transition metal composition and that of rotor substrates made of magnetic steel, on which magnets are surface mounted. Temperature cycling can initiate cracks in adhesive layers between magnets and steel substrate. Furthermore, ultimate temperature of operation can be limited for similar reasons preventing storage or transportation where ambient temperature can reach −40° C.

A further problem to be solved for motors of the present invention is rotors can have resonance frequencies coinciding with commonly used speeds of operation and there is value in dampening vibrations whilst maintaining other characteristics.

Another problem to be solved for motors of the present invention is maintaining the temperature of permanent rare-earth transition-metal magnets commonly used, to 130° C. or thereabouts, that is to say at a peak temperature well below their curie temperature. Eddy currents generate heat in permanent magnets during a motor's operation and magnets may be radially laminated to reduce eddy currents, however, making laminations loses useful magnetic material and is costly and the number of laminations are limited by a cost/benefit balance. As a result, eddy currents though reduced, still generate heat in permanent magnets.

The majority of electric dynamo machines comprise a rotor and stator wherein flux traverses radially between rotor and stator i.e. generally orthogonal to axis of rotation and antagonistic reaction between stator and rotor flux urges the rotor to rotate, so called radial flux machines. Radial flux machines generate considerable centripetal force when the rotor is rotating. Radial flux machines have been mechanically improved to accommodate centripetal force by wrapping rotors with fibre reinforced with a resin matrix. US2004/0021396 is one such example and JP10210690 another, wherein fibres provide strength in the circumferential direction and maintain structural integrity of the rotor against centripetal forces.

Although the majority of electric dynamo machines commercially available are of radial flux design there is increasing interest in axial flux machines as described herein. However particularly for axial flux machines operating at high rotation speed there are considerable challenges due to combined axial and radial forces during operation.

It is an object of the invention to provide a rotor in which at least some of the disadvantages associated with known rotor designs are overcome or are of reduced effect.

### SUMMARY OF THE INVENTION

The present invention provides a rotor for a rotary electric machine, and a method of assembling a rotor for a rotary electric machine, as defined by the independent claim appended hereto. Further advantageous embodiments are provided by the dependent claims, also appended hereto.

In particular, we describe a rotor for a rotary electric machine, the rotor comprising a support disc having opposing first and second faces; a support member for receiving a plurality of permanent magnets; a plurality of permanent magnets mounted to and retained by the support member; and a retaining band extending around the permanent magnets, restricting or preventing radial outward movement of the permanent magnets, in use, and the retaining band being pre-stressed to apply an inward, radially directed load to the plurality of magnets, wherein the support member is secured to the first face of the support disc.

The use of a support member retaining the permanent magnets in the construction of a rotor, where the support member and magnets are secured to the first face of the support disc, and the retaining band, which is pre-stressed to apply an inward, radially directed load to the plurality of magnets even when stationary enables a rotor to be constructed that is able to achieve higher rpm than conventional rotors.

The support member may comprise a plurality of spokes extending radially, and wherein the spaces between adjacent spokes define a gap for receiving a respective permanent magnet.

Alternatively, the support member may comprise an annular part from which a plurality of spokes project radially therefrom, each of the spaces between adjacent spokes defining a socket for receiving a respective permanent magnet.

The support member may be co-moulded with the magnets and may be formed from a Sheet Moulding Compound (SMC) material.

5 Alternatively, the support member may be co-moulded with the magnets and the support member may be formed from an injection moulded polymer.

The annular part and the spokes forming the support member may be formed of separate pieces.

In such a rotor, the annular part may comprise a plurality of deformable structures extending radially outwards, each of the deformable structures being located on the annular part to coincide with a respective spoke. Each of the deformable structures contact and provide a radial force against a respective spoke.

The annular part may be formed from an injection moulded polymer.

Each of the spokes may be formed from a uni-directional carbon strip, and wherein the fibres of each of the carbon strips run perpendicular to the axial length of the respective spoke.

Each of the spokes may be formed from a material having isotropic properties in a plane that extends radially along the length of a respective spoke and a plane that extends perpendicular to the radial plane.

Each of the spokes may be formed from a magnetic material. The magnetic material may have a magnetic field alignment that is orthogonal to a magnetic field alignment of one or more of the plurality of permanent magnets.

The retaining band may comprise a composite material. By way of example, it may comprise windings of a reinforcing fibre material within a matrix of a suitable resin material. The fibre material may be of, for example, carbon fibre or glass fibre form. Conveniently, the fibre material is substantially hoop wound.

Preferably, the support member and permanent magnets are shaped so as serves to react the loads imparted to the magnets by the retaining band to substantially prevent the magnets from moving radially inwards as a result of the loads applied by the retaining band.

In order to prevent relative movement between the support member and/or permanent magnets and/or retaining band, any gaps between the support member and permanent magnets and/or between the permanent magnets and retaining band may be filled with a polymer resin.

The support member may be secured to the first face of the support disc using an adhesive. Preferably the permanent magnets may be secured to the support disc by bonding using an adhesive of relatively low modulus.

As the retaining band serves to retain the permanent magnets against radial movement, it will be appreciated that the primary purpose of the adhesive material is to prevent the permanent magnets from lifting from the surface of the support disc.

By way of example, in the context of the present invention, a high modulus adhesive would be considered to have a modulus of greater than 500 MPa. Epoxy typically has a modulus in the region of 1-5 GPa. A semi rigid adhesive may have a modulus between 20 MPa and 500 MPa. An adhesive of low modulus would have a modulus of about 20 MPa or lower. Silicone adhesives typically have a modulus in the region of 1-2 MPa.

In use, as mentioned hereinbefore, the rotor is subject to significant loads arising from centripetal effects and magnetic attraction and repulsion. It is important that the permanent magnets are retained in position upon the support disc and, through the use of an adhesive material of low modulus, the magnets can be retained in position upon the support disc whilst accommodating limited movement between the magnets and the support disc. Low modulus materials typically exhibit a high strain to failure, or elongation under load. For example where an epoxy adhesive can accommodate a small amount of elongation, a silicone adhesive can accommodate a few 100% elongation. It is this strain capability or flexibility that allows for relative movement between components to be accommodated.

The adhesive material is preferably of good thermal conductivity, for example better than 0.5 W/m·K.

The support disc preferably comprises a first annular member, conveniently of steel form, to which a second annular member is bonded. The second annular member is preferably of laminated form. It may comprise a spiral wound coil of laminated electrical steel. Such an arrangement has the advantage that it is of relatively high radial electrical resistance, combatting the occurrence of eddy currents, whilst enabling the traversal of magnetic flux.

The first and second annular members are conveniently bonded or otherwise secured to one another using a material of good thermal conductivity. By way of example, they may be secured to one another by epoxy bonding, silver soldering, brazing, or using other suitable eutectic or eutectic region bonding media. Preferably the first and second annular members are bonded or otherwise secured to one another using a material having a thermal conductivity that is greater than 0.5 W/m K, more preferably greater than 10W/m K.

We also describe a rotary electric machine comprising a stator and a rotatable rotor taking the form of the above-described rotor. The rotary electric machine may be an axial flux machine such as a motor or generator. In such an axial flux machine, the stator is located between a pair of rotors taking the above-mentioned form.

Furthermore we describe a method of assembling a rotor for a rotary electric machine, comprising: providing a support disc having opposing first and second faces; providing a support member having a plurality of permanent magnets mounted thereto; locating a pre-stressed retaining band to extend circumferentially around the outer radius of the permanent magnets, the retaining band for restricting or preventing radial outward movement of the permanent magnets in use and the pre-stressing applying an inward, radially directed load to the permanent magnets; and securing the support member to the first face of the support disc.

Providing a support member having a plurality of permanent magnets mounted thereto may comprise: locating a stiffener structure in a mould tool, the stiffener structure comprising a plurality of spokes projecting radially from an annular part, each of the spaces between adjacent spokes defining a socket for receiving a respective permanent magnet; locating respective permanent magnets in each of the sockets; and bonding each of the permanent magnets to the stiffener structure.

The annular part and respective spokes of the stiffener structure may be formed of a single part. Alternatively, the annular part and respective spokes of the stiffener may be formed of separate parts.

When the spokes and stiffener are formed of separate parts, the annular part may comprise a plurality of deformable structures extending radially outwards, each of the deformable structures being located on the annular part to coincide with a respective spoke. Each of the deformable structures may contact and provide a radial force against a respective spoke when placed in the mould tool.

The annular part may be formed from an injection moulded polymer.

Each of the spokes may be formed from a uni-directional carbon strip, and wherein the fibres of each of the carbon strips run perpendicular to the axial length of the respective spoke.

Each of the spokes may be formed from a material having isotropic properties in a plane that extends radially along the length of a respective spoke and a plane that extends perpendicular to the radial plane.

Each of the spokes may be formed from a magnetic material. The magnetic material may have a magnetic field alignment that is orthogonal to a magnetic field alignment of one or more of the plurality of permanent magnets.

In any of the above methods, bonding each of the permanent magnets to the stiffener structure may comprises injecting a resin to fill gaps between one or more of the respective magnets and respective spokes and annular part.

Alternatively, bonding each of the permanent magnets to the stiffener structure may comprise using an adhesive between each of the permanent magnets and respective spokes and portion of annular part to bond each of the permanent magnets to the stiffener structure.

In an alternative method, providing a support member having a plurality of permanent magnets mounted thereto may comprise: locating a plurality of permanent magnets in a mould tool, the magnets being arranged circumferentially around an axis and having gaps between each of the permanent magnets; and forming a stiffener structure around the permanent magnets in the mould tool.

Forming the stiffener structure around the permanent magnets in the mould tool may comprise: using a plurality of SMC (Sheet Moulding Compound) pre-forms, each being arranged as a spoke projecting radially outwardly in a gap between respective adjacent permanent magnets; and compressing the plurality of SMC pre-forms to form the stiffener structure.

The stiffener structure comprises an annular inner part, from which the spokes are formed to project.

The SMC pre-forms may comprise a thermoset resin.

Providing a support member having a plurality of permanent magnets mounted thereto may comprise: injection moulding using a polymer to form a stiffener structure comprising a plurality of spokes projecting radially outwardly, each spoke being formed between adjacent permanent magnets.

The stiffener structure may comprise an annular inner part, from which the spokes are formed to project, and wherein the annular inner part is formed during the injection moulding using the polymer.

The injection moulded polymer may comprise a polymer having fibres therein.

In any of the above methods, the retaining band may be of a composite material. The retaining band may comprise windings of a reinforcing fibre material within a matrix of a suitable resin material. The fibre material may be substantially hoop wound.

In any of the above methods, the support member and permanent magnets may be secured to the first face of the support disc using an adhesive. The adhesive may have a relatively low modulus. The modulus of the adhesive may be less than 20 MPa.

The adhesive material may be of higher thermal conductivity than epoxy. The adhesive material may have a thermal conductivity greater than 0.5 W/m·K.

### LIST OF THE FIGURES

The invention will further be described, by way of example, with reference to the accompanying drawings, in which:

FIGS. 1 and 2 are views illustrating a rotor in accordance with an embodiment of the invention;

FIG. 3 is an exploded view illustrating the rotor of FIGS. 1 and 2;

FIG. 4 is a diagrammatic illustration showing the rotor of FIGS. 1 to 3, in use;

FIG. 5 is a diagrammatic representation illustrating part of the rotor and the loadings experienced thereby;

FIG. 6 shows an inner radial ring of one aspect of the support member;

FIG. 7 shows the inner radial ring of FIG. 6 in a mould tool with spokes prior to a resin based filler being applied; and

FIG. 8 shows an example UD pultrusion showing cut lines to form each of the spokes.

### DETAILED DESCRIPTION OF THE PREFERRED EMBODIMENTS

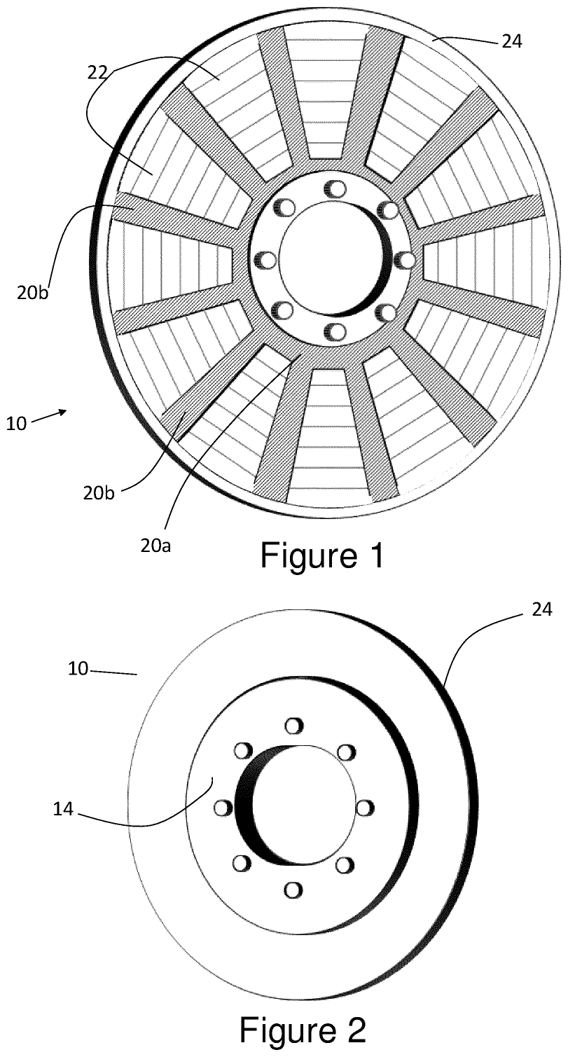

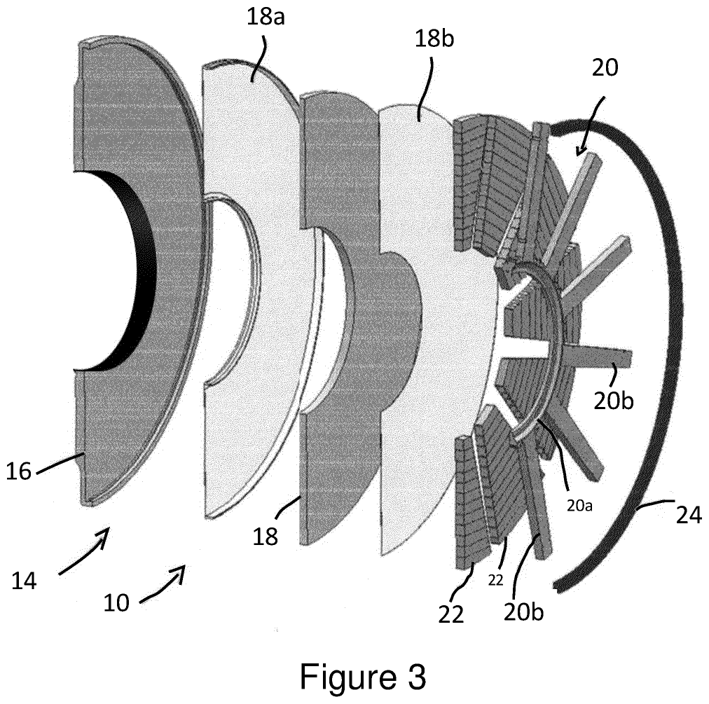

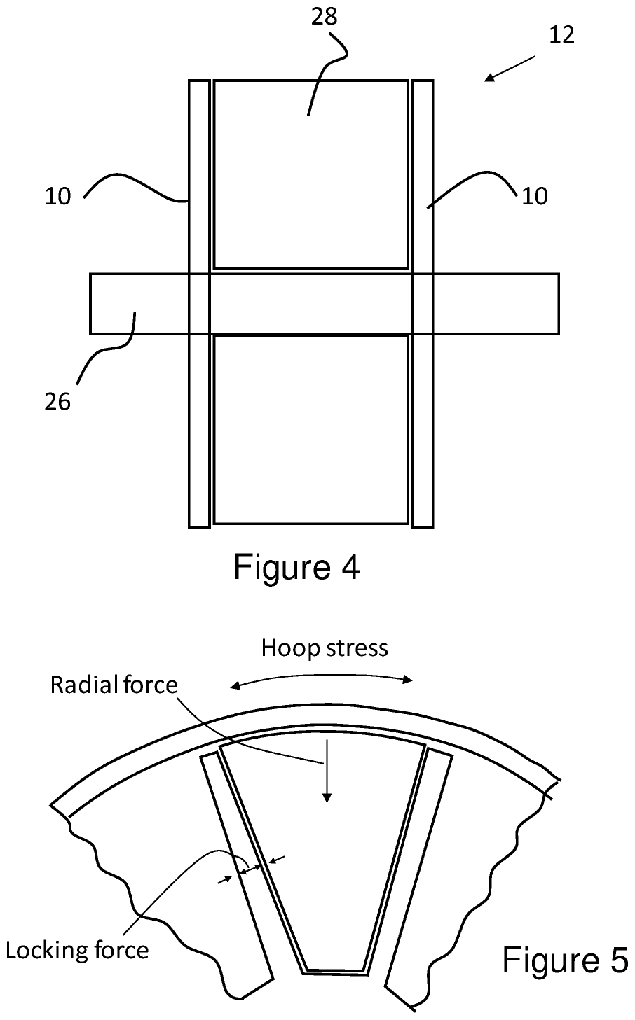

Referring firstly to FIGS. 1 to 3, a rotor 10 is illustrated for use in a rotary electric machine 12 (see FIG. 4) that, in this embodiment, takes the form of an axial flux motor. Whilst the rotor 10 is intended for use in an axial flux motor, it will be appreciated that the invention is not restricted in this regard, and that the rotor 10 could be used, either as shown or in modified form, in a generator, for example.

The rotor 10 comprises a support disc 14 made up of a first annular member 16 of steel form to which a second annular member 18 is bonded or otherwise secured, for example by an adhesive 18a or the like, the second annular member 18 taking the form of a spiral coil of an electrical steel material, the windings of which are laminated to one another in such a manner as to form a body that is of relatively high radial electrical resistance and so reducing the occurrence of eddy currents therein, whilst being of a form that readily permits the traversal of magnetic flux between the faces thereof. The first and second annular members 16, 18 are bonded or otherwise secured to one another in such a manner that they are very closely spaced relative to one another and such that thermal energy can readily be conducted therebetween. By way of example, the first and second annular members 16, 18 may be brazed to one another. Alternatively, they could be bonded to one another using a suitable epoxy adhesive material (as shown), a suitable eutectic material or the like.

The first annular member 16 serves as a structural support for the remainder of the rotor 10.

Whilst steel is used for the first annular member 16 in the arrangement illustrated, it will be appreciated that other materials could potentially be used. By way of example, a suitable ceramic or composite material could be used, if desired.

Bonded, by an adhesive material 18b, to the face of the second annular member 18 remote from the first annular member 16 is a support member 20. In a first aspect, the support member 20 is of a non-magnetic material, and is shaped to define a central annular part 20a from which a plurality of generally radially projecting spokes 20b extend. Adjacent ones of the spokes 20b define therebetween sockets or spaces within which respective permanent magnets 22 are located. The permanent magnets 22 and the support member 20 are bonded to the second annular member 18 using the adhesive material 18b. The adhesive material 18b may be any type of adhesive material that is suitable for bonding the permanent magnets 22 and support member 20 to the second annular member.

The adhesive material 18b may, for example, be an adhesive such as an epoxy (or have similar characteristics or modulus to epoxy adhesives), which would provide a strong, rigid bond between the magnets 22 and support member 20 and the second annular member. However, it is preferable that the adhesive material 18b is one having a low or relatively low modulus and is of relatively high thermal conductivity. By way of example, the adhesive material 18b may be of a silicone based form. Other examples of suitable materials include low modulus epoxy adhesives, polyurethane adhesives, acrylic adhesives and nitrile phenolic adhesives. It will be appreciated that this list is not exhaustive and that other materials could be used. In order to achieve the advantages of the invention, the strain to failure, or elongation, of the material should be sufficient to absorb all relative movements of the components that occur in normal use such that the stress in the adhesive does not carry significant radial loads. By way of example, the modulus should be less than 20 MPa, and should preferably be in the region of 1 MPa to 5 MPa.

Surrounding the radially outer peripheries of the magnets 22 is a retaining band 24, the purpose of which is to apply a radially inwardly directed load to the magnets 22, urging them into the socket or spaces between the spokes 20b of the support member 20. The retaining band 24 is of a fibre reinforced composite material. By way of example, it may comprise windings of a suitable reinforcing fibre material such as carbon fibre, embedded within a suitable resin material matrix. The retaining band 24 is conveniently manufactured to be of a relaxed diameter smaller that the outer diameter of the part of the rotor 10 defined by the permanent magnets 22, the retaining band 24 being resiliently stretched over the permanent magnets 22 during the assembly process to prestress the retaining band 24 in such a manner that the retaining band 24 applies the aforementioned radially directed loads to the magnets 22.

It will be appreciated that the retaining band 24 applies a relatively large radially inwardly directed load to the magnets 22, and one of the functions of the support member 20 is to react these loads. When bonded with a low modulus adhesive material, the support member 20 reacts substantially all of the radially inward loads applied to the magnets 22 that, without the support member 20, would result in failure of the adhesive joints. The shapes of the sides of the magnets 22 and adjacent parts of the support member 20 are such that a locking force arises between the magnets 22 and the support member 20 as a result of the hoop stress generated in the retaining band when fitted. The locking force arises from the radially inwardly directed loads urging the sides of the magnets 22 against the sides of each leg of the support member 20 as a result of the magnets 22 being wedge shaped. The magnets 22 thus become locked against the support member 20 with the legs thereof compressed between adjacent ones of the magnets 22, as illustrated diagrammatically in FIG. 5. The modulus of this support member is important in making the rotor function and reacting the loads as the magnets are relatively stiff. By way of example, the support member 20 may be of a material with a high carbon fibre content. It should preferably have a modulus in excess of 20 GPa.

The support member 20 may be of injection moulded form, or could alternatively be of press moulded form, machined or finished to substantially the shape illustrated, for example. However, in some aspects, some manufacturing techniques (which we will discuss below) enable the support member 20 to be formed without the inner annular part 20a. Conveniently, the support member 20 and magnets 22 are preassembled to form a subassembly that is subsequently bonded, as a unit, to the second annular member 18 by the adhesive 18b.

In a first manufacturing technique, the support member 20 as a single piece is loaded into a moulding tool, that is the support member 20 comprises the inner annual part 20a, and a plurality of spokes 20b. The production of the subassembly preferably includes a step of filling, for example with a suitable resin based filler material, any spaces or voids between the magnets 22 and the support member 20, for example with the magnets 22 and the support member 20 located within a suitably shaped mould. The support member 20 may be designed to be slightly under size for this purpose, and the legs thereof of a length such that they do not project radially outward of the magnets 22, and so do not engage the retaining band 24, in use.

Alternatively, instead of providing the support member 20 as a single piece, the support member 20 may be provided as separate pieces, that is an inner annual ring 20a and a separate plurality of spokes 20b are loaded into a moulding tool with the plurality of magnets before the resin based filler material is applied between the gaps.

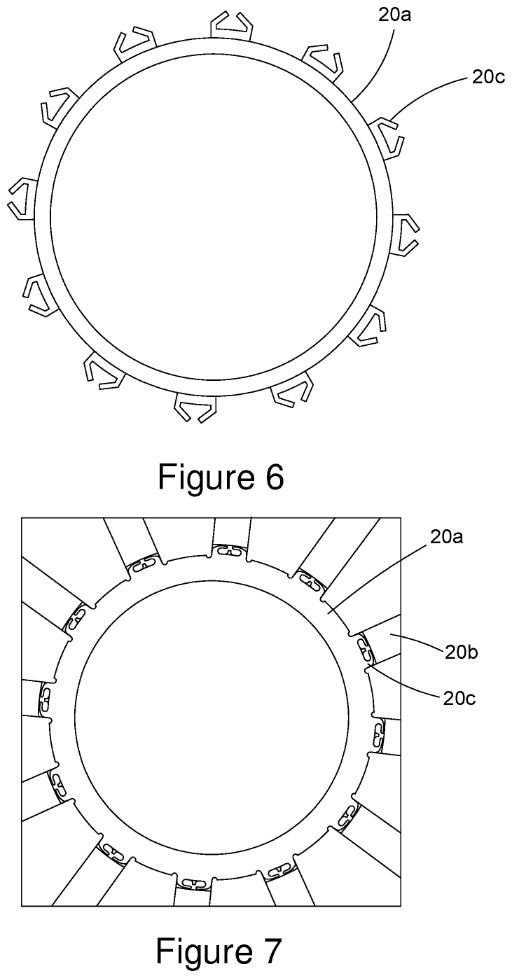

FIG. 6 shows an inner radial ring of one aspect of the support member. FIG. 7 shows the inner radial ring of FIG. 6 in a mould tool with spokes prior to a resin based filler being applied.

In such a manufacturing technique, the inner annual ring 20a may be provided with a plurality of deformable structures 20c at intervals around its circumference. The purpose of each of the deformable structures 20c is to contact a respective spoke 20b and provide a radial force against the spoke 20b to retain the spoke in position prior to the resin based filler is applied between the gaps. Once the resin based filler has been applied, the structures are fixed in place.

When the support member 20 is provided as separate pieces, this enables the different parts comprising the support member 20 to be made from different materials having different properties.

For example, the spokes 20b may comprise of a uni-directional (UD) carbon strip. For example, the spokes 20b may be cut from a pultruded profile, which is a continuous manufacturing process suitable for making predominantly UD strip materials in high volume with low labour content.

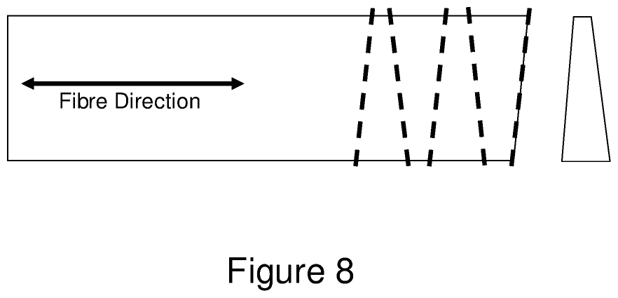

FIG. 8 shows an example UD pultrusion showing cut lines to form each of the spokes 20b prior to assembling into the mould tool.

Using spokes 20b comprising UD carbon fibre pultrusion greatly increases the stiffness of the spokes, particularly across their width. For example, the planar modulus across their width may be in the region of 110-130 Gpa, compared to their planar modulus along their length being in the region of 5 Gpa.

Alternatively, the spokes 20b may comprise of an isotropic, or quasi-isotropic material. For example, a material having isotropic properties in the XY plane (where the XY plane is the face of the support member and magnets). Such materials couple comprise a Glass fibre SMC (Sheet Moulding Compound) may have an XY planar modulus of 10-20 GPa, a Carbon Fibre SMC would be higher, typically around 30-40 GPa—this can be increased by selecting higher modulus grades of Carbon Fibre. In the Z plane, (through thickness) the modulus may be lower, for example in the region of 5-10 GPa.

The spokes 20b may instead comprise a magnetic material. In such an arrangement, the magnetic field alignment of the spokes 20b is arranged to be orthogonal to the magnetic field alignment of the permanent magnets 22. For example, if the permanent magnets are arranged as N-S pairs, the spokes 20b may be arranged as having a E-W alignment. Such an arrangement may provide a Halbach array, which may improve the magnetic performance of the rotor due to augmentation of the magnetic field.

In any of the above-mentioned manufacturing techniques, the inner ring 20a may be injection moulded. Its material properties are not as influential on the performance of the rotor as the magnet 22 and spoke 20b location.

As described before, the inner ring 20a may instead not be present, in which case the permanent magnets 22 are held by the spokes 20b in the moulding tool prior to the resin based filler being applied.

By producing the subassembly in this manner, it can be ensured that the magnets 22 are in intimate contact with the support member 20 and filler material, minimising or avoiding movement therebetween. Accordingly, upon subsequent fitting of the retaining band 24, no significant movement of the magnets 22 should occur, which would introduce stress or strain into the adhesive material 18b.

Whilst the above-mentioned manufacturing techniques use a resin based filler material once the components (inner ring 20a, where applicable, spokes 20b and magnets 22) are located in the moulding tool, an alternative technique involves using an adhesive between some or all of the components (inner ring 20a, where applicable, spokes 20b and magnets 22). Such a technique provides a much stronger joint strength between the respective components, particularly between the magnets 22 and the spokes 20b, compared to when a resin based filler is used.

Broadly speaking, an alternative, co-moulding, assembly technique comprises locating the magnets 22 within a suitable mould, and to mould the support member 20 in situ between the magnets 22. Such a co-moulding technique avoids the need to fill voids or spaces with a filler material as no such voids or spaces will be present, the magnets 22 and support member 20 being in intimate contact with one another as a result of the manner in which the—support member 20 is formed.

In such a co-moulding technique, the magnets 22 may be place within a lower tool, and clamped or held in place. SMC (Sheet Moulding Compound) preforms are un-cured and pliable at this stage and just cut rectangles of material. The SMC may comprise a thermoset resin. The SMC preforms are loaded into the tool and an upper tool is introduced and compresses the SMC material, forcing it to flow to the final shape of the spokes 20b and inner ring 20a (although the tool may be shaped not to provide an inner ring 20a for the support member 20).

Using the co-moulding technique, the load path of from the magnets is directly into the SMC material and produces a sub-assembly of support member 20 and magnets 22 that has a high overall stiffness.

It will be appreciated that the rotor 10 described hereinbefore is of single sided form with the magnets 22 bonded to a face of the support disc 14 made up of the first and second annular discs 16, 18 and the support member 20. In use, a pair of such rotors 10 may be mounted upon a common rotor shaft 26 and located so that a single stator 28 is located axially between the rotors 10, the stator 28 including coils that, in use, are energised to induce magnetic fields cooperating with the permanent magnets 22 to drive the rotors 10, and the rotor shaft 26 upon which they are mounted for rotation. In some configurations, the rotors 10 may be mounted to a bearing housed by the stator 28.

In use the rotation of the rotor 10 about its axis results in the permanent magnets 22 being subject to significant centripetal loads, and the prestressed retaining band 24 serves to counter those loads, retaining the permanent magnets 22 in position. The interactions between the magnetic flux of the permanent magnets 22 and the fields associated with the stator coils results in the application of significant loads in a direction lifting the permanent magnets 22 away from the support disc 14 and/or causing the permanent magnets to twist or tilt relative to the support disc 14. When the permanent magnets 22 are bonded to the support disc 14 using a low modulus adhesive material, the low modulus adhesive is able to flex, in use, accommodating such twisting movements whilst maintaining the integrity of the bonds between the permanent magnets 22 and the support disc 14. The low modulus adhesive material can also accommodate movements arising from differential thermal expansion of parts of the rotor 10, and in particular between the magnets 22 and the second annular member 18, which can be significant as mentioned hereinbefore.

In the case where the support member 20 and permanent magnets 22 are bonded to the support disc using an adhesive having a higher modulus, the arrangement of the support member 20 and permanent magnets 22 and prestressed band 24 still work to prevent movement between the support disc and magnets. In use the rotation of the rotor 10 about its axis results in the permanent magnets 22 being subject to significant centripetal loads, and the prestressed retaining band 24 serves to counter those loads, retaining the permanent magnets 22 in position. The interactions between the magnetic flux of the permanent magnets 22 and the fields associated with the stator coils results in the application of significant loads in a direction lifting the permanent magnets 22 away from the support disc 14 and/or causing the permanent magnets to twist or tilt relative to the support disc 14, all of which are prevented by the adhesive.

The thermal conductivity of the material used to bond the permanent magnets 22 to the support disc 14, in combination with the design of the support disc 14, allows conduction of thermal energy away from the magnets 22 for dissipation elsewhere within the motor.

It will be appreciated that the invention is advantageous in that the permanent magnets are secured to the remainder of the rotor 10 in such a manner that loss of a magnet, in use, and associated catastrophic damage to the motor, can be avoided, whilst allowing the motor to be operated at high speeds, for example at speeds in excess of 15000 rpm, and in a range of operating environments.

Although the rotor 10 described hereinbefore is intended for use in a motor of the type in which a stator is located between a pair of single sided rotors, the invention is not restricted to such use and may be employed with others forms of motor and other forms of rotary electric machine.

Whilst a specific embodiment of the invention is described hereinbefore, it will be appreciated that a wide range of modifications and alterations may be made thereto without departing from the scope of the invention as defined by the appended claims.

1. A rotor for a rotary electric machine, the rotor comprising:
a support disc having opposing first and second faces;
a support member for receiving a plurality of permanent magnets;
a plurality of permanent magnets mounted to and retained by the support member; and
a retaining band extending around the permanent magnets, restricting or preventing radial outward movement of the permanent magnets, in use, and the retaining band being pre-stressed to apply an inward, radially directed load to the plurality of magnets,
wherein the support member is secured to the first face of the support disc.

2. The rotor according to claim 1, wherein the support member comprises a plurality of spokes extending radially, and wherein the spaces between adjacent spokes define a gap for receiving a respective permanent magnet.

3. The rotor according to claim 1, wherein the support member comprises an annular part from which a plurality of spokes project radially therefrom, each of the spaces between adjacent spokes defining a socket for receiving a respective permanent magnet.

4. The rotor according to claim 2, wherein the support member is co-moulded with the magnets and is formed from a Sheet Moulding Compound (SMC) material.

5. The rotor according to claim 3, wherein the support member is co-moulded with the magnets and the support member is formed from an injection moulded polymer.

6. The rotor according to claim 3, wherein the annular part and the spokes are formed of separate pieces.

7. The rotor according to claim 6, wherein the annular part comprises a plurality of deformable structures extending radially outwards, each of the deformable structures being located on the annular part to coincide with a respective spoke.

8. The rotor according to claim 7, wherein each of the deformable structures contact and provide a radial force against a respective spoke.

9. The rotor according to claim 6, wherein the annular part is formed from an injection moulded polymer.

10. The rotor according to claim 6, wherein each of the spokes is formed from a uni-directional carbon strip, and wherein the fibres of each of the carbon strips run perpendicular to the axial length of the respective spoke.

11. The rotor according to claim 6, wherein each of the spokes is formed from a material having isotropic properties in a plane that extends radially along the length of a respective spoke and a plane that extends perpendicular to the radial plane.

12. The rotor according to claim 6, wherein each of the spokes is formed from a magnetic material.

13. The rotor according to claim 12, wherein the magnetic material has a magnetic field alignment that is orthogonal to a magnetic field alignment of one or more of the plurality of permanent magnets.

14. The rotor according to claim 1, wherein the retaining band is of a composite material.

15. The rotor according to claim 14, wherein the retaining band comprises windings of a reinforcing fibre material within a matrix of a suitable resin material.

16. The rotor according to claim 15, wherein the fibre material is substantially hoop wound.

17. The rotor according to claim 1, wherein the support member and permanent magnets are shaped so as to react the loads imparted to the magnets by the retaining band to substantially prevent the magnets from moving radially inwards as a result of the loads applied by the retaining band.

18. The rotor according to claim 4, comprising a polymer resin material between portions of the permanent magnets, the support member and/or the retaining band.

19. The rotor according to claim 1, wherein the support member and permanent magnets are secured to the first face of the support disc using an adhesive.

20. The rotor according to claim 19, wherein the adhesive is of relatively low modulus.

21. The rotor according to claim 20, wherein the modulus of the adhesive is less than 20 MPa.

22. The rotor according to claim 20, wherein the adhesive material is of higher thermal conductivity than epoxy.

23. The rotor according to claim 22, wherein the adhesive material is of thermal conductivity greater than 0.5 W/m·K.

24. The rotor according to claim 1, wherein
the support disc comprises a first annular member to which a second annular member is bonded.

25. The rotor according to claim 24, wherein the first annular member is of steel form.

26. The rotor according to claim 24, wherein the second annular member is of laminated form.

27. The rotor according to claim 26, wherein the second annular member comprises a laminated spiral wound coil.

28. The rotor according to claim 24, wherein the first and second annular members are bonded or otherwise secured to one another using a material having a thermal conductivity greater than 10 W/m·K.

29. A rotary electric machine comprising a stator and a rotatable rotor, the rotor taking the form of claim 1.

30. The rotary electric machine according to claim 29 and comprising an axial flux motor or axial flux generator.

31. The rotary electric machine according to claim 30, wherein the stator is located between a pair of rotors.

32. A method of assembling a rotor for a rotary electric machine, comprising:
providing a support disc having opposing first and second faces;
providing a support member having a plurality of permanent magnets mounted thereto;
locating a pre-stressed retaining band to extend circumferentially around the outer radius of the permanent magnets, the retaining band for restricting or preventing radial outward movement of the permanent magnets in use and the pre-stressing applying an inward, radially directed load to the permanent magnets; and
securing the support member to the first face of the support disc.

32.-59. (canceled)
